(19) United States
(12) Patent Application Publication
(10) Pub. No.: US 2010/0297277 A1
(43) Pub. Date: Nov. 25, 2010

(54) Extrusion Device

(75) Inventor: Florian Fischer, Ebersberg (DE)

Correspondence Address: ROBERT W. BECKER & ASSOCIATES, 707 HIGHWAY 333, SUITE B, TIJERAS, NM, 87059-7507, US

(73) Assignee: VMI-AZ Extrusion GmbH, Runding (DE)

(21) Appl. No.: 12/785,856

(22) Filed: May 24, 2010

(30) Foreign Application Priority Data
May 22, 2009 (DE) 10 2009 022 370.3

(51) Int. Cl. B29C 47/26

(52) U.S. Cl. 425/113

(57) ABSTRACT

An extrusion device comprising an extruder screw for conveying extrudable material, in particular natural or synthetic rubber materials. The extrusion device also comprises a nozzle having two nozzle dies that are displaceable relative to one another. Furthermore, the extrusion device comprises a reinforcing material feeder for conveying reinforcing material in the direction of the nozzle, via which reinforcing material and extrudable material are discharged together from the extrusion device. The reinforcing material is guided in a horizontal plane of separation.

The instant application should be granted the priority dates of May 22, 2009, the filing date of the corresponding German patent application 10 2009 022 370.3.

### BACKGROUND OF THE INVENTION

The invention relates to an extrusion device.

An extrusion device with the aid of which threads are encased by rubber material and are extruded therewith has been known for a long time, for example from U.S. Pat. No. 2,760,230 or GB 950 741. With solutions of this kind, wires or threads are fed to a nozzle with the aid of a thread guide, and between the thread guide and the nozzle rubber material enters the region of the threads, thus encasing the threads. Solutions of this kind have been employed and are employed in various forms.

With the manufactured article it is important to have a sufficient anchorage or mounting of the threads in the extrusion material in order to achieve the desired effect. Indeed, the diameter of the threads could be reduced and thus the contact surface relating to the weight of the threads could be considerably increased. Very thin threads, however, may only be poorly guided through the extrusion nozzle and in some case are unsuitable, too, for example if a certain rigidity or stiffness of the manufactured article is to be achieved by means of the threads.

In order to increase the anchorage or mounting with given thread diameters it has been proposed to carry out a surface roughening of the threads. This is comparatively complex and costly and also only possible with some thread materials. Moreover, it would be desirable to be able to manufacture different products with the same extruder.

An improvement in this respect can be taken from DE-C2 28 13 217. This document represents a solution, with the aid of which the thread guide may be shifted or displaced relative to the nozzle such that an adaptation to the intended combination of rubber, thus substantially to the temperature and therewith to the viscosity thereof, and to the thread used, thus the thread material and the thread thickness, is possible.

This solution, however, is not entirely satisfactory if a quick refitting for different products to be extruded is to be provided.

A further problem is the fact that the threads often break. With twisted filaments, the breakage of a single filament is comparatively less critical if the filaments are well embedded in the rubber compound. In the case of a monofilament, however, or in the case of polyfilaments that are relatively poorly fixed to one another and that each are subject to separate tensile loads, this is critical and it must be ensured that the filaments of the thread meet the no-break criterion in the manufactured article.

An essential reason why a change and a new introduction of the product to be extruded is often not effected, although this would be displayed despite a breakage of the thread or filament, is the difficulty to newly load the thread guide, especially if many single filaments or threads are existent.

This, for example, may be carried out by having the extrusion head run empty and by pulling out from behind and reloading the thread guide after having loosened the respective screws.

In this respect, the invention is based on the object of producing an extrusion device of the aforementioned type which enables an improved handling even in the case of a breakage of the thread such that there is an enhanced possibility to carry out a refitting of a reinforcing material feeder in the case of a possible thread breakage.

### SUMMARY OF THE INVENTION

This object is inventively solved by an extrusion device that comprises an extruder screw for conveying extruder material, in particular natural or synthetic rubber materials; a nozzle having two nozzle dyes that are displaceable relative to one another; and a reinforcing material feeder for conveying reinforcing material in the direction of the nozzle, via which nozzle reinforcing material and extrudable material are discharged together from the extrusion device, wherein the reinforcing material is guided in a horizontal plane of separation.

According to the invention it is particularly favorable to open the possibility of making the reinforcing material feeder accessible by separating the nozzle dies and for example of markedly easily replacing broken filaments. Surprisingly, a notedly high pressure for the extrusion head may be employed nevertheless, offering special advantages with respect to the adherence of the rubber compound to the surface of the filaments or to the reinforcing material, such as load-carrying cords. For this reason it is possible without further ado to provide a pressure of for example 400 bar within the feed or supply region for the extrusion compound, that is to say in the region between reinforcing material feeder and nozzle. Such a pressure allows to take advantage of the microroughness of the surface of the filaments and allows penetration of parts of the rubber compound at this location. The surface effects produced in this manner considerably increase the adherence such that a large contact surface of the reinforcing material may be exploited.

The extrusion device according to the invention allows with simple means to make adjustable the relative position of the reinforcing material feeder to the nozzle. In this way, the remaining free space may be adapted to the requirements, for example the nature and condition of the reinforcing material, to a large extent.

By moving apart the nozzle dies it is possible to mount the reinforcing material feeder in a freely accessible manner, whereas both simple repositioning and a machine process are possible.

It is preferred that the reinforcing material feeder is then held in position by the pressure of the nozzle dies on top of one another such that a manual adjustment device for the positioning of the reinforcing material feeder is not loaded or stressed by the extrusion pressure.

It is also possible in this connection to locate specific positions with the aid of a grid such as a corrugation or ribbing.

It is preferred that the flow to the reinforcing material feeder occurs laterally from the outlet of the extruder screw. Through this, the rubber or a different extrudable mass laterally impinges on the reinforcing material. With the aid of a horizontal variable position of the reinforcing material feeder, the different flow length or duration may be compensated so that despite a drop in pressure, a uniform exit speed with several products that are generated in parallel, is feasible.

According to the invention it is particularly favorable if cords are used as reinforcing material. If a cord breaks or ruptures during the production, the cords can be rapidly changed due to the fact that the reinforcing material feeder can be easily released according to the invention.

A further advantage of the inventive extrusion device is the ease of exchangeability of the nozzle inserts. Due to the dispartment or separateness and the relative movability of the nozzle dies relative to one another, the nozzle insert may be changed rapidly in the usual manner and may thus be adapted to the desired shape of the product to be extruded.

According to the invention it is also possible to arrange a plurality of nozzles and correspondingly associated nozzle dies next to one another. The upper nozzle dies as well as the lower nozzle dies may then preferably be connected to one another, respectively, whereas they may be realized in one upper nozzle carrier. The nozzle carriers may then be movable relative to one another whereas the direction of movement is preferably vertical so that all upper nozzle dies may together be separated from all lower nozzle dies.

According to the invention it is particularly favorable if the nozzle dies are substantially of semi-circular shape in order to receive or accommodate a nozzle insert. The nozzle insert is then changeable and provides the nozzle slot having the respective suitable shape. With the aid of a form-fit mounting known per se of the nozzle inserts in the nozzle dies, the high extrusion pressures may be absorbed without further ado.

The drive device according to the invention inventively keeps the nozzle dies tightly on top of one another during the extrusion process. In order to support the pressing or forming pressure of the drive device in the closed condition of the extrusion device, a strong electromagnet may be provided for example that is switched on during the extrusion and that is switched off during the movement of the nozzle dies, in particular for separating the nozzle dies from one another, or a combination of a stud and a nut.

It is to be understood that the drive device may be embodied in any suitable manner. Preferably, the drive device is embodied with a least one hydraulic cylinder that allows rapid opening and closing of the nozzle dies.

According to the invention it is provided that the discharge or exit direction of the reinforcing material feeder runs transversely to the axis of the extruder screw, in particular substantially at right angles thereto.

According to the invention it is provided that the discharge or exit direction of the reinforcing material feeder passes through the nozzle, in particular is arranged coaxially thereto.

According to the invention it is provided that the nozzle comprises a nozzle insert that is surrounded by the nozzle dies and that in particular forms a nozzle slot.

According to the invention it is provided that the nozzle dies in the closed condition of the extrusion head surround the nozzle insert in an annular manner.

According to the invention it is provided that two nozzles are arranged next to one another that comprise nozzle dies, whereas the upper nozzle dies are collectively displaceable relative to the lower nozzle dies.

According to the invention it is provided that a drive device is formed within an extrusion head of the extrusion device, via which an upper nozzle carrier may be separated from a lower nozzle carrier, whereas said drive device in particular operates in a hydraulic or pneumatic manner.

According to the invention it is provided that the reinforcing material feeder may be released or unblocked by separating the nozzle dies from one another.

According to the invention it is provided that the reinforcing material feeder is formed in two pieces and is comprised of a lower and an upper part, with said parts being able to be pressed on one another by bringing together the nozzle carriers via a drive device.

According to the invention it is provided that the separation or dispartment of the nozzle dies takes place in a horizontal direction, and the drive device for the nozzle carriers of the nozzle dies acts in a vertical direction.

According to the invention it is provided that the active surfaces of the nozzle carriers facing one another, thus in particular the exposed surfaces facing one another, are formed without protrusions or undercuts, and in particular no screws, bolts, etc. extend between the nozzle carriers apart from the drive device for the nozzle carriers.

According to the invention it is provided that a free space is formed between the reinforcing material feeder and a nozzle insert of the nozzle, said free space extending around the reinforcing material.

According to the invention it is provided that a free space that is formed between the nozzle insert and the reinforcing material feeder completely surrounds the reinforcing material and in particular, if represented in section, is formed such that it substantially runs towards a nozzle slot in a V-shape.

According to the invention it is provided that the decrease or drop in pressure with a lateral oncoming flow towards the nozzles through the extruder screw is compensated with the aid of fluidic means.

### BRIEF DESCRIPTION OF THE DRAWINGS

Further advantages, details and features emerge from the following description of an embodiment of the invention in connection with the drawings, in which:

FIG. 1 represents a schematic view of an embodiment of the invention with the nozzle dies being closed;

FIG. 2 represents the embodiment shown in FIG. 1 with the nozzle dies being moved apart from one another;

FIG. 3 represents the embodiment shown in FIG. 1 and FIG. 2 in the open condition, however, in a lateral sectional view; and

FIG. 4 represents a sectional view through an inventive extrusion device in the afore-said embodiment in the closed condition.

### DESCRIPTION OF SPECIFIC EMBODIMENTS

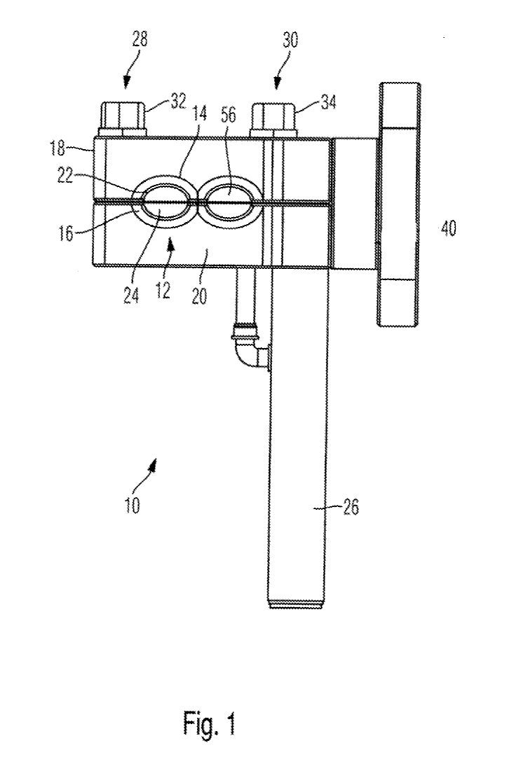

The extrusion device 10 represented in FIG. 1 comprises a nozzle 12 that is provided with two nozzle dies or orifices 14 and 16 in the represented embodiment. These nozzle dies 14 and 16 are formed at an upper nozzle carrier 18 and at a lower nozzle carrier 20 and substantially together surround a nozzle insert 22 in an annular manner, said nozzle insert in turn comprising a nozzle slot 24. The nozzle carriers 18 and 20—and thus the nozzle dies 14 and 16—are slidable or movable relative to one another. In this respect, a drive device 26 is provided that acts in vertical direction and via which the upper nozzle carrier 18 may be separated from the lower nozzle carrier 20 by moving or displacing the upper nozzle carrier 18 upwards.

In the closed condition of the nozzle dies 14 and 16, the nozzle carriers 18 and 20 incidentally lie flat on top of one another. In the embodiment shown, additional studs or screw bolts 28, 30 with respective nuts 32 and 34 are provided for the safe closing of the nozzle carriers 18 and 20 relative to one another, with the aid of which studs and nuts a fixation of the nozzle carriers 18 and 20 to one another is realized. It is to be understood that instead of these means, any other fixing means may be provided and that it is also possible to ensure the closed condition of the nozzle 12 in any other manner.

As can be seen in FIG. 1, there is provided an incidentally smooth and straight mold parting line or plane of separation 40 between the nozzle carriers 18 and 20, and the studs 28 and 30 pass through the upper nozzle carrier 18.

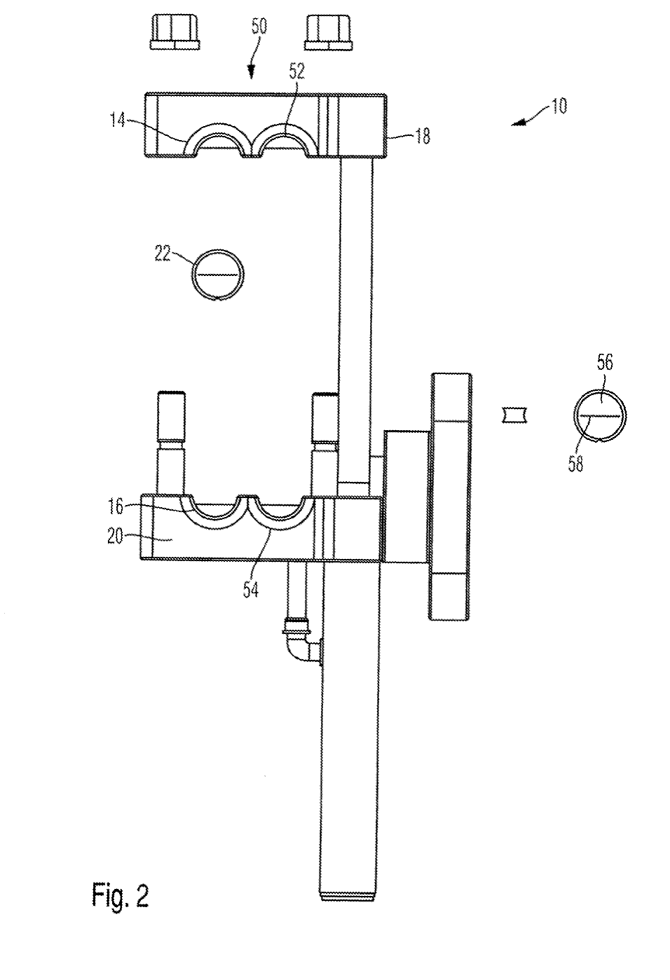

FIG. 2 shows how the nozzle carriers 18 and 20 may be separated or moved apart from one another. As it can be seen in the figure, the nozzle dies 14 and 16 are separated from one another in this way. In the exemplary embodiment shown here, a further nozzle 50 is arranged adjacent to the nozzle 12, said further nozzle 50 also having two nozzle dies 52 and 54 opposite to one another and corresponding to the nozzle dies 14 and 16 in its design. The upper nozzle die 52 together with the upper nozzle die 14 is formed at the upper nozzle carrier 18, and the lower nozzle die 54 together with the lower nozzle die 16 is formed at the lower nozzle carrier 20. The nozzle dies 52 and 54 accommodate a further nozzle insert 56 that is provided with a nozzle slot 58 and is incidentally formed similarly to the nozzle insert 22.

As is apparent from FIG. 2, the nozzle inserts 22 and 56 may be removed and exchanged in any suitable manner.

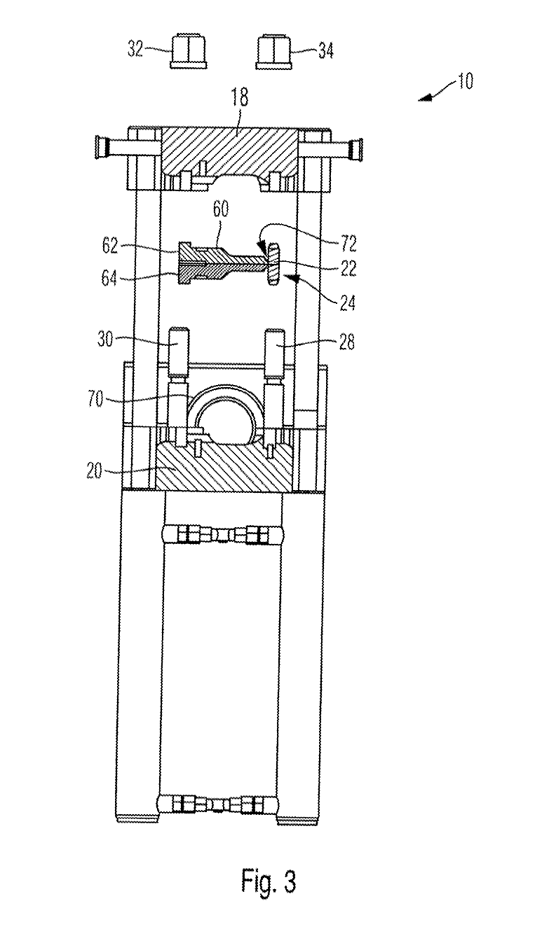

In FIG. 3 it is shown in which manner a reinforcing material feeder 60 is accommodated or received within the inventive extrusion device 10. The reinforcing material feeder 60 is formed in two pieces and is comprised of an upper part 62 and a lower part 64. It may be displaced in the horizontal direction in order to be able to adjust the distance to the respective nozzle insert 22. The reinforcing material feeder, in a manner known per se, comprises in its two parts 62 and 64 grooves, in particular half-round grooves, that guide or carry reinforcing material (not shown) and supply it to the nozzle slot (24).

Laterally adjacent to the reinforcing material feeder 60, the extruder screw 70 is formed that enables to evenly fill the free space 72 between the reinforcing material feeder and the nozzle insert 22 with natural or artificial rubber and hence to encase the reinforcing material.

In the closed condition of the nozzle carriers 18 and 20, the reinforcing material feeder 60 is pressed together at a given position so that the parts thereof firmly rest on one another.

It is obvious that the reinforcing material feeder 60 is freely removable and exchangeable in the represented condition according to FIG. 3 so that the reinforcing material may be inserted there without further ado, if required, for example if a reinforcing material cord or the like breaks or ruptures during the production process.

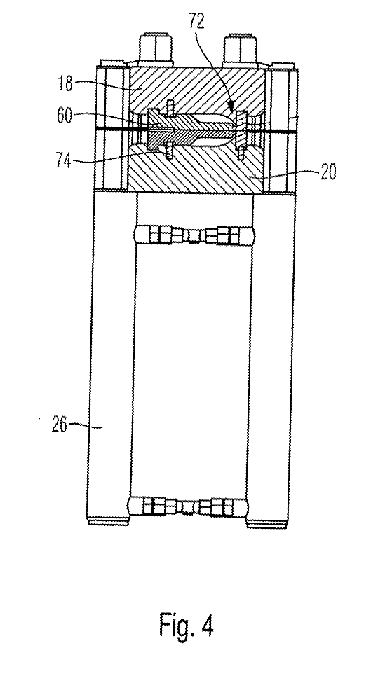

FIG. 4 shows in which manner the reinforcing material feeder 60 is fixed between the upper nozzle carrier 18 and the lower nozzle carrier 20. As is apparent, the reinforcing material feeder is not movable in vertical direction, however in horizontal direction, that is to say in the exit direction of the nozzle 12. In this respect, it is horizontally mounted above a guide element 74 with clearance, so that a free space 72 relative to the nozzle 12 may be adjusted.

The specification incorporates by reference the disclosure of German priority document 10 2009 022 370.3 filed May 22, 2009.

The present invention is, of course, in no way restricted to the specific disclosure of the specification and drawings, but also encompasses any modifications within the scope of the appended claims.

I claim:

1. An extrusion device, comprising:
an extruder screw for conveying extrudable material;
a nozzle having two nozzle dies that are displaceable relative to one another; and
a reinforcing material feeder for conveying reinforcing material in the direction of said nozzle, via which nozzle reinforcing material and extrudable material are discharged from said extrusion device, wherein said reinforcing material is guided in a horizontal plane of separation.

2. An extrusion device according to claim 1, wherein a discharge or exit direction of said reinforcing material feeder extends transverse to an axis of said extruder screw.

3. An extrusion device according to claim 2, wherein said discharge or exit direction of said reinforcing material feeder extends substantially at right angles to the axis of said extruder screw.

4. An extrusion device according to claim 1, wherein a discharge or exit direction of said reinforcing material feeder passes through said nozzle.

5. An extrusion device according to claim 4, wherein said discharge or exit direction of said reinforcing material feeder is disposed coaxially relative to said nozzle.

6. An extrusion device according to claim 1, wherein said nozzle is provided with a nozzle insert that is surrounded by said nozzle dies.

7. An extrusion device according to claim 6, wherein said nozzle insert forms a nozzle slot.

8. An extrusion device according to claim 6, wherein in a closed state said nozzle dies surround said nozzle insert in an annular manner.

9. An extrusion device according to claim 1, wherein each of said nozzle dies has a substantially semi-circular configuration.

10. An extrusion device according to claim 1, wherein two nozzles are disposed next to one another, further wherein each of said nozzles is provided with said nozzle dies, and wherein upper ones of said nozzle dies are displaceable together relative to lower ones of said nozzle dies.

11. An extrusion device according to claim 1, which further comprises an extrusion head and a drive device formed in said extrusion head, wherein an upper nozzle carrier is provided for one of said nozzle dies and a lower nozzle carrier is provided for the other of said nozzle dies, and wherein said drive device is configured to separate said upper nozzle carrier from said lower nozzle carrier.

12. An extrusion device according to claim 11, wherein said drive device is configured to operate hydraulically or pneumatically.

13. An extrusion device according to claim 11, wherein separation of said nozzle carriers for said nozzle dies from one another is adapted to release said reinforcing material feeder.

14. An extrusion device according to claim 11, wherein said reinforcing material feeder has a two-part configuration comprised of an upper part and a lower part, and wherein said upper and lower parts are adapted to be pressed against one another by bringing said nozzle carriers together via said drive device.

15. An extrusion device according to claim 11, wherein a separation of said nozzle dies extends in a horizontal direction, and wherein said drive device for said nozzle carriers of said nozzle dies acts in a vertical direction.

16. An extrusion device according to claim 11, wherein active surfaces of said nozzle carriers that face one another, i.e. in particular the exposed surfaces that face one another, are configured so as to be free of protrusions or undercuts between said nozzle carriers with the exception of said drive device for said nozzle carriers.

17. An extrusion device according to claim 1, wherein said nozzle is provided with a nozzle insert, further wherein a free space (is formed between said reinforcing material feeder and said nozzle insert, and wherein said free space extends about the reinforcing material.

18. An extrusion device according to claim 17, wherein said free space completely surrounds the reinforcing material.

19. An extrusion device according to claim 18, wherein when viewed in section said free space has an essentially V-shaped configuration in a direction toward a nozzle slot.

20. An extrusion device according to claim 1, wherein said nozzle is configured to receive a lateral flow from said extruder screw, and wherein fluidic means are provided to compensate for a pressure drop.
